(19) United States
(12) Patent Application Publication
(10) Pub. No.: US 2014/0115658 A1
(43) Pub. Date: Apr. 24, 2014

(54) Multi-User Interactive Multimedia Chat

(71) Applicant: Adekunle Ayodele, Snellville, GA (US)

(72) Inventor: Adekunle Ayodele, Snellville, GA (US)

(21) Appl. No.: 14/057,963

(22) Filed: Oct. 18, 2013

Related U.S. Application Data
(63) Continuation-in-part of application No. 14/057,936, filed on Oct. 18, 2013.
(60) Provisional application No. 61/716,538, filed on Oct. 21, 2012.

(51) Int. Cl. G06F 21/64

(52) U.S. Cl. CPC G06F 21/64
USPC 726/1

(57) ABSTRACT

Provided is a method of establishing a multimedia interactive chat room populated with a pseudo-random sampling of available participants. The pool of available participants is defined as the group composed of members of an online community whose user accounts have been reviewed by system administrators for appropriateness of content and consistency between captured videos and submitted biographical data. Results of sample selection are displayed to the requesting user, who can then decide to begin multimedia interactive chat sessions with one or more users, or may select a “reshuffle” option, which results in the display of a new sample of available members. Requesting users can limit the type of persons displayed by selecting filters such as interest based filters. Users are thus provided with the ability to speak with other community members without all participants having to actively enter a chat room website.

### CROSS REFERENCE TO RELATED APPLICATION

This application claims the benefit of U.S. Provisional Application No. 61/716538 filed on Oct. 21, 2012. This application is a continuation in part of application Ser. No. 14/057,936 filed on Oct. 18, 2013. The patent applications identified above are incorporated here by reference in its entirety to provide continuity of disclosure.

### BACKGROUND OF THE INVENTION

1. Field of the Invention

The present invention relates to a method of providing an interactive multimedia chat for a digital community. More specifically, it relates to a method for populating a multi-user chat room with a pseudo-random sample from an existing population of community members. The population of eligible community members is limited to those persons who have provided live capture video files of themselves

Chat rooms, are online social gatherings facilitated by software applications. These software applications may be installed on a computing device of each individual user or may be an embedded application within a webpage. Each embodiment includes hosting of the chat on a web server. Online chat rooms provide participants with tools to commence real-time conversation amongst users. These conversations may be public, published to the entire chat room, or alternatively may be private, between two specific users. Some chat rooms offer only public or private conversation capabilities, while others offer a combination of both.

Online chat rooms are generally populated by persons who actively sign in to the website or software application and then choose a chat room in which to participate. Chat rooms may be themed according to interests, age, gender, marital status, or other demographic. Persons wishing to speak with others interested in stock trading can join a chat room themed for “investment advice.” But, this chat room will be populated only by others who actively chose to participate in this particular discussion at the time. Most chat rooms do not offer users the opportunity to filter all available users by interest, and therefore do not give users the opportunity to speak with others of similar interest who are not participants in a particular chat room, but may be in a differently themed chat room.

Those chat rooms that do permit users to chat individually with other users based on interest selections, do not offer the user a sample of the available users who meet their criteria. These systems select a community member or system user based on specified criteria, and establish a chat session between the requesting user and the selected individual. The requesting user is not provided with a sample of members who meet the criteria, nor is the requesting user given the opportunity to continuously obtain a fresh sample.

A common problem associated with online chat room participation is the risk of interaction with individuals purporting to someone they are not. These fraudulent users create an account and provide false biographical data in order to fool other users. Advertisers, predators, and those participating in criminal activity are common culprits of fraudulent account creation and abuse. If left unchecked, these users may take advantage of chat room participants.

A method of providing a multi-user interactive chat room is need that provides pseudo-random samples of potential chat participants and reduces the proliferation of fraud. The present invention addresses these issues by requiring review of user accounts and providing vetted users with the ability to populate a chat room with a sample of users meeting the requirements of the requesting user.

2. Description of the Prior Art

The present method of providing a multimedia interactive chat contains steps not disclosed in the prior art. The method includes the steps of performing a check to ensure operability of a user's audio-video capture device, and populating a multi-person chat room from a pseudo-random sample of available community members. The method further provides users with the ability to select filters to limit the type of chat participants, and permits them to obtain a new sample of members by “shuffling” the chat room. The following is a list of prior art systems and methods deemed relevant to the present disclosure.

Kalinowski, U.S. Patent Publication No. 2008/0059580 discloses a method for providing video chat to users across a network. Video streaming between users is facilitated over a network, and displayed to each chat participant in conjunction with identifying information. An initiating user finds a person within the online social network that they would like to commence video chat communications. If the receiving user consents to the chat, the system initiates a video chat between the two participants, comprising a video window and a chat dialog window. Unlike the present invention, Kalinowski does not provide chat room users a pseudo-random sample of all chat participants, nor does it provide users with the ability to “shuffle” the chat room and receive a new sample of available participants.

Zherg, U.S. Patent Publication No. 2008/0288870 discloses a system and method for multi-user video communication. The Zherg system employs one or more servers to stream and store audio-video communications. Each communication is sorted by the system and published to a thread, blog, or website, where it is visible to users. The Zherg invention does not facilitate live communications between users, but rather facilitates the sending of messages therebetween. The present invention is a method of providing live multimedia interactive sessions, and does not include the steps of posting a stored video to a blog as part of the communications between users.

Talukder, U.S. Patent Publication No. 2012/0268553 teaches a method of flow-control during an interactive broadcast session. The method establishes a single broadcaster and a number of participant listeners. These listeners can interact with the broadcaster during a broadcast session via chat, but they cannot share a video stream with the broadcaster or the other participants. Thus the method provides a platform for digital audio-video lecture, rather than open two-way communications as is provided by the present invention.

Cahill, U.S. Patent Publication No. 2012/0236103 discloses a system for pseudo-anonymous video chat. The platform requires that users create a profile including several fields of biographical data and interest. A matching algorithm executed by the system then selects potential chat partners for the user based on the user's preferences. These results are then displayed to the user, who can select a chat partner and begin an audio-video chat session. Unlike the present invention, the Cahill platform does not allow re-shuffle available chat partners, filtering of an obtained sample of potential participants, or the review of user profiles prior to enabling the multimedia interactive session.

These prior art devices have several known drawbacks. They do not disclose the ability to “shuffle” the chat room to obtain a new sample of available potential participants. Further, they do not disclose the ability to limit the participants of a chat room based on selected filters. The present method clearly provides these features in steps described herein. It substantially diverges in design elements from the prior art and consequently it is clear that there is a need in the art for an improvement to existing methods of providing a chat room. In this regard the instant invention substantially fulfills these needs.

### SUMMARY OF THE INVENTION

In view of the foregoing disadvantages inherent in the known types of methods of providing a multimedia interactive chat now present in the prior art, the present invention provides a new multi-user pseudo-random sampling wherein the same can be utilized for providing convenience for the user when providing a chat room in a digital community.

The present invention is a method for providing an interactive multimedia chat room. Chat room participants are all vetted users of a digital community interacting over a network. The accounts of each community member are reviewed during the account creation process to ensure that multimedia files associated with each user's profile are appropriate and consistent with biographical data. Once review by a system administrator is complete, the account is published and the biographical data is used to facilitate selection of participants in the multimedia chat.

Users accessing the chat room are required to have an audio-video recording device in operative communication with the computing device accessing the web server hosting the digital community. Software integrated the system performs a check on the user's computing device to verify operation of the audio-visual recording device, before chat room entry is finalized. Upon successful completion of the check, the requesting user is given access to the chat room and a sample of available community members is displayed. The user can select a member to initiate a chat session with, or select from a plurality of filtering options and “reshuffle” the chat room to bring up a new sample of members, selected from the group of those persons whose biographical data meets the criteria of the requesting user. To this end the present invention provides a dynamic multimedia chat experience that can be controlled and filter by users. Similarly, the invention reduces the potential for fraud by providing review of accounts of during account generation, thereby parsing out suspicious accounts prior to abuses.

It is therefore an object of the present invention to provide a new and improved multimedia chat method that has all of the advantages of the prior art and none of the disadvantages.

It is another object of the present invention to provide a method of populating a multi-user chat room with a pseudo-random sample of available community members.

Another object of the present invention is to provide a chat room in which users can limit chat room population based on a plurality of filters such as interests and biographical data.

Yet another object of the present invention is to provide a multimedia interactive chat room that only permits entry by users with an active audio-video capture device in operative communication with their computing device.

Still another object of the present invention is to provide a chat room that can only be populated by persons with accounts approved by a system administrator. The review process including a comparison between a live captured video and biographical data submitted by the user.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exemplary depiction of the user interface of the multimedia chat specific page in use.

FIG. 2 shows a flow diagram of account generation prerequisite to use of the multimedia interactive session.

FIG. 3 shows a flow diagram of system administrator review process prerequisite to multimedia interactive session participation.

FIG. 4 shows a flow diagram of the multimedia interactive chat method.

### DETAILED DESCRIPTION OF THE INVENTION

Reference is made herein to the attached drawings. Like reference numerals are used throughout the drawings to depict like or similar elements of the method of providing a multimedia interactive chat. For the purposes of presenting a brief and clear description of the present invention, the preferred embodiment will be discussed as used for establishing a chat populated by a sample of community members. The figures are intended for representative purposes only and should not be considered to be limiting in any respect.

The method discussed herein provides safe means of meeting new people through an online multimedia chat. System administrators review the user accounts of all chat participants during the account generation process, thereby reducing the risk of fraud during interactive sessions. The invention accomplishes this by incorporating a requirement for the live capture of a video during the account generation process, and then subjecting the resultant multimedia file to scrutiny by system administrators. By reviewing submitted multimedia files to ensure that they are appropriate in nature and the depicted user appears to be the same as the person described in corresponding biographical data, system administrators can parse out accounts that are clearly deceptive. Further, the method provides for obtaining a permanent video record of community participants. The process reduces the creation of accounts that are visibly fraudulent, such as those purporting to be held by celebrities, or those pretending to be an age or gender other than their own. Integrity of interactions between users is protected by thus removing predators and con artists from the pool of potential chat participants. In this manner, chat participants can safely interact with random persons.

Herein is described an implementation of a network environment conducive to use of the present method. One or more client computing devices such as a laptop, tablet computer, smart phone, or desktop computer (hereinafter referred to generally as “client”) are in communication with at least one server via a network. Each client is operatively and electrically connected to a text input means and a web-camera or other audio-video capture device. The use of the terms “client and server in the singular is not intended to limit the method to a single client or single server embodiment. During the practice of the method, the network environment may include any number of client computing devices in communication with any number of servers over the network. Similarly, multiple networks may be employed to connect groups of servers or groups of client computing devices together, thereby creating sub-networks. In general, the term network is intended to refer to the “Internet”, but wide area networks (WAN) may also be used, and it will be understood by one of ordinary skill in the art that the method is not limited to implementation on only this network.

Each client and server is implemented as a computing device having a system bus in communication with at least the components of: a central processing unit; a main memory; a storage memory; an input/output (I/O) controller; display devices; and a network interface. An operating system and various software routines are stored on the storage memory. Input/Output devices such as a keyboard, touchpad, touchscreen, mouse, speakers, and the aforementioned audio-video capture device may be connected to the I/O controller. Of these devices only a text input means and, pointer device, and audio-visual capture device are necessary for the implementation of the present invention. Audio output via speakers is also desirable but is not required. The addition of further components or substitution of different configurations of a component will be known to one of ordinary skill in the art and are not enumerated in detail herein.

Each of said servers may run an application stack comprising but not limited to web servers, file upload/download servers, associated databases, and authentication applications. The upload/download server and databases may be integrated with the web server application. A web server includes sub-applications for hosting a website and providing client-side services, as well as facilitating client access to said one or more databases. It is preferable that document-oriented databases capable of indexing, sorting, and querying multimedia files be used in the implementation of the present method. Selected databases should be scalable to avoid limitations on effectiveness of the method. Partitioning strategies such as database sharding may be implemented to promote greater scalability. Clients can access these databases via a website hosted on said web server, pending successful login with the authentication application. Authentication may consist of password checking, credential verification, or confirmation of other identifying information.

In addition to storage of multimedia files, and one or more databases, the one or more servers shall also run a webserver to host an online portal such as a website (hereinafter referred to as “website”). Implementation of the online portal is not limited to a particular language, client browser configuration, or design. It is preferable that the online portal is implemented using JAVA (Oracle Corporation of Redwood, Calif.) and Flash (Adobe Systems, Inc of San Jose, Calif.). Other languages and web-based software applications may be substituted as needed by one of ordinary skill in the art to accomplish the steps described herein.

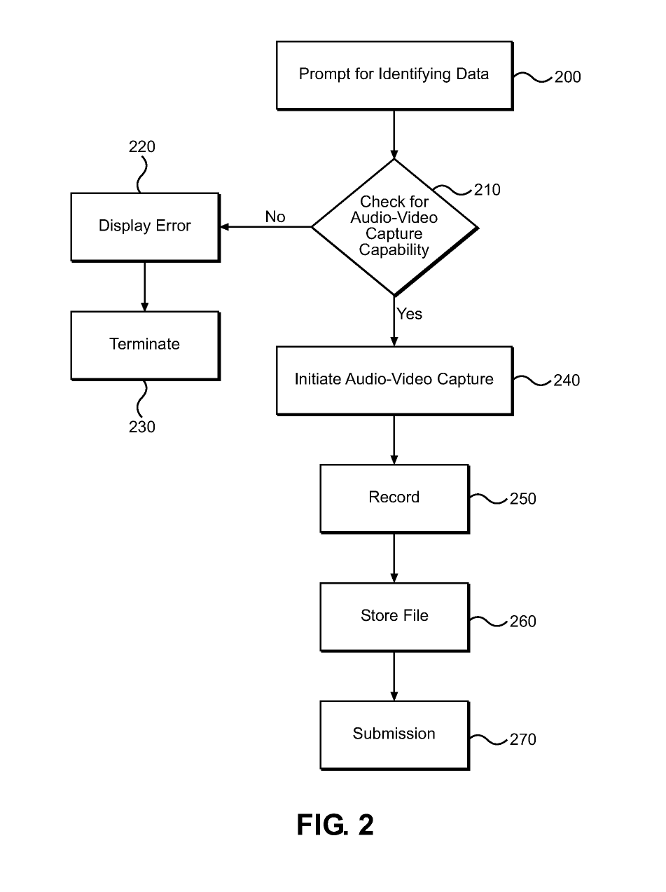

Referring now to FIG. 2, there is shown a diagram of the account creation process. To begin the process a client accesses the web site hosted on the web server. The potential user then interacts with an on-screen indicia presented via a web page, which is displayed in a client web browser. Examples of appropriate indicia are textual links stating, “sign up, and buttons marked “create an account.” Interaction with the indicia results in the display of a prompt for the user to input identifying data 200. This prompt may be in the form of a new webpage, series of pop-up or overlay windows within the web browser. By way of example, a series of fields with textual prompts indicating the information to be entered into field may be displayed to the user. During this input process, users may have access to a link, pop-up window, or other notification means that provides information regarding a pre-determined set of use rules, which regulate the content of multimedia files.

Next, the web server accesses the client machine over the network and checks for an audio-video capture device in operative connection with the client I/O controller 210. Audio-video capture is an essential component of the present process, because multimedia file contents are reviewed by system administrators for signs of fraud. If the result of the capture device check is negative, an error message is displayed 220 to the user via the client screen and the process is terminated 230.

An audio-video capture device check that confirms an operational audio-video recording device returns a positive result to the server. The web server then communicates with the client machine, signaling the beginning of audio-video capture 240. Optionally, the capture may be preceded by an on-screen prompt indicating that a user should confirm their readiness to begin audio-video capture by interacting with indicia. Upon receipt of the communication from the server, the client computing device signals the I/O controller to initiate recording via the audio-video capture device 250. Recording continues for a predetermined period of time established by system administrators. A recording termination communication is sent to the client by the server at the end of the predetermined recording period, or at a time slightly preceding the end of the predetermined time interval. The client receives this termination communication and signals the I/O controller to cease recording.

Transmission and storage of captured audio-video 260 may be accomplished through several methods. In some embodiments, captured data is streamed over the network to the server for storage, during the capture process. Streamed data is received and stored on the server and indexed within the database. Alternatively, in other embodiments, captured data is stored locally on the storage memory and transmitted to the server upon completion of the capture process. In either embodiment, the resultant multimedia file is stored on the server and indexed within one of said databases. The database may be a separate structure designated for account generation request information, or alternatively, the information may be incorporated into a general user database.

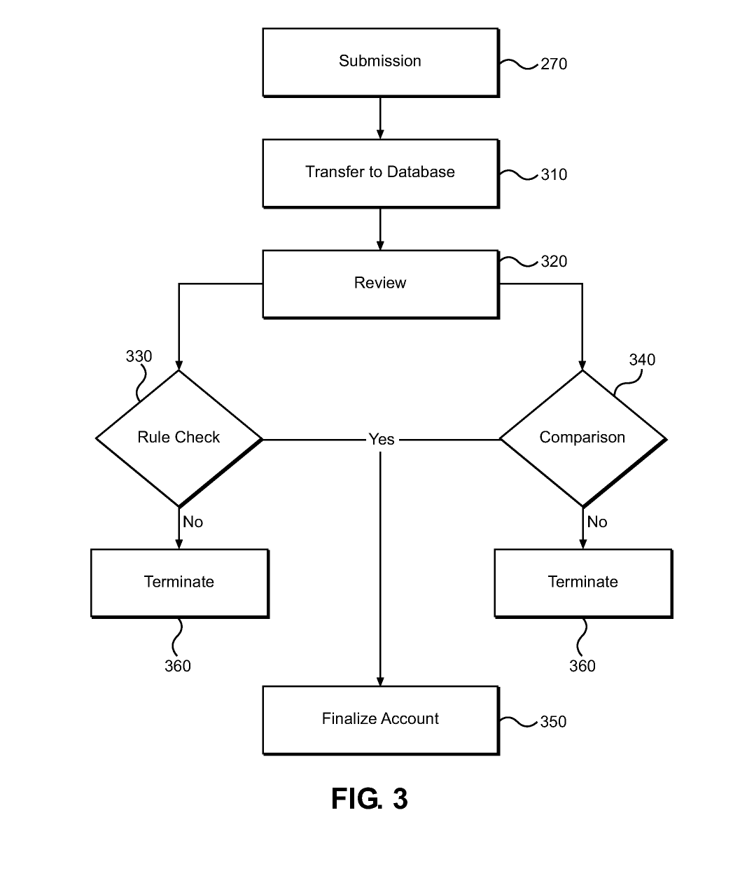

In some embodiments, a user is provided with an opportunity to review the captured video file prior to submission. The multimedia file may be played back in a web browser window and a user prompted for their approval of the captured clip. If the user does not approve the video, the audio-video capture process may repeat until the user is satisfied with the multimedia file produced. Alternatively, the initially captured audio-video file may be stored without prompting the user for his or her approval. In either embodiment, the process is not completed until submission of the input data and multimedia file 270. The account generation process is further depicted in FIG. 3. Upon submission the information and multimedia file are indexed within the database 310 and an identifier added, which indicates that the account is pending review.

Once submitted, requests are reviewed by a system administrator, who can approve or deny the request. Pending finalization of an account, the requesting user does not have access to web server services beyond those available to the general public. Private web services, upload/download server access, and database access are inaccessible to persons without finalized accounts.

System administrators view submitted account generation requests via an administrator portal that is preferably integrated into the web site running on the web server. Data input by the user is visible to a system administrator via the administrator interface along with the submitted multimedia file. Review of the requested account 320 comprises a two-part check of the submitted data and content. If both checks return positive results then the account is approved and finalized 350.

In some embodiments, the first check performed is a check for appropriateness of content 360. To reduce the inadvertent exposure of web site users to erotic, mature, or offensive content, the multimedia file captured during creation of the account generation request is reviewed to verify that it contains appropriate content 330. This review maybe a visual review of the multimedia file in which a reviewing administrator watches the entire length of the file playback. If the file contains material that is not in compliance with the pre-determined use rules, the administrator terminates the account generation process 360. It is preferred that termination results in the transmission of an e-mail, text, or other notification message to the user. The message may address the reasons for request denial, or may simply state that the request did not comply with the use rules.

In some embodiments, a comparison check is the first check performed. The order and duration of the comparison check 340 and appropriateness check 330 is immaterial, so long as each step is performed prior to finalization. Comparison checks may be performed by a system administrator viewing and listening to the multimedia file, or alternatively may be performed by facial recognition software scanning the multimedia file. The contents of the filed are compared against the submitted biographical data to discover any inconsistencies. By way of example, biographical data listing a female of 30 years should match the person depicted in the multimedia file. If the biographical data does not match the depicted person, the administrator terminates the approval process 360. In embodiments incorporating facial recognition software, a failed comparison returns an error to the administrator who then terminates the process. Positive matches from either a manual or automated comparison check results in a prompt for the administrator to finalize the account 350.

Once the account is finalized, the user is notified via e-mail, text, or other notification message and access privileges are assigned. The user can then access some restricted portions of the website, upload multimedia files and participate in web site services. By way of example the multimedia chat becomes accessible to users once their accounts are approved. User sign-in via the authentication application may be required in order for a user to gain access to the aforementioned services.

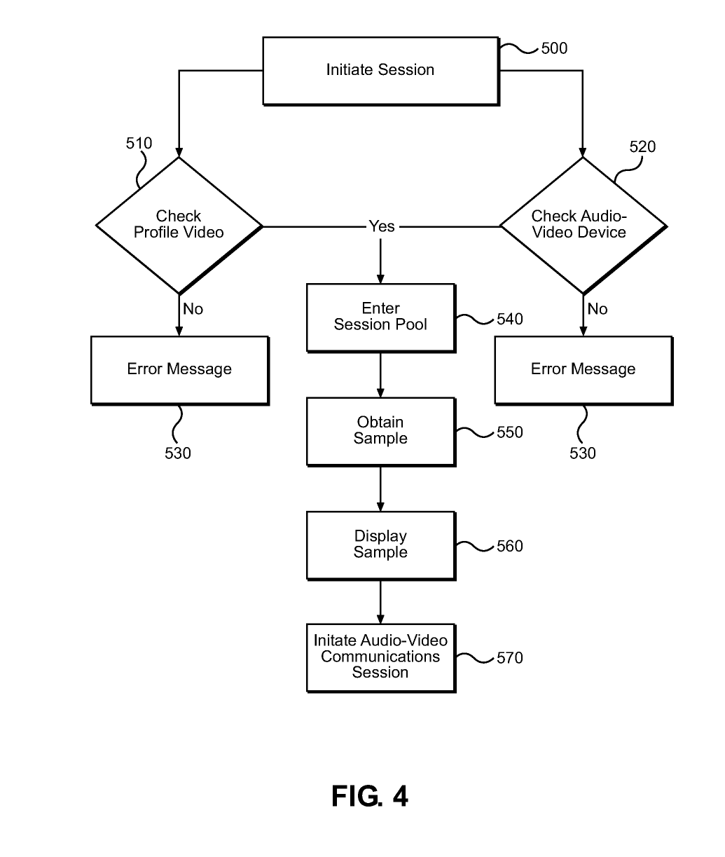

Turning now to FIG. 4, there is shown a flow diagram of the user end of the multi-user multimedia chat. The multi-user chat function is preferably provided as a sub-application of the web server. Users start a multi-user multimedia chat session by interacting with an on-screen indicia presented via a web page associated with the web server. Interaction with the indicia results in the initiation of a multi-user chat session 510 by the system. Before the user is permitted to enter the chat session, the web server performs two checks. If either check returns a negative result the process terminates 530 and an error message is displayed to the user.

In some embodiments the first check is internally completed server-side. The web server queries the one or more databases using an identifier associated with the account of the authenticated user. If the user account was properly generated using the above-described process, the database query returns an association with a profile video or alternatively, a profile image joined to a profile video. Resultantly, the check returns a positive result. If no profile video or image is found then the check returns a negative result and the process terminates. This check is essential to the present method, because it ensures that only persons who have been checked or fraudulent accounts may participate in multi-user chat sessions. Thus, system administrators effectively imply that all chat participants are likely to be the person they purport. In this way, the present method protects the integrity of user interactions.

In some embodiments, a second check is made externally over a network. This check determines whether an audio-video capture device is operational and active in the client. This step is performed in the same manner as step 240 as discussed above. Every time a user accesses the multi-user multimedia chat, an audio-video capture device check is performed. This is a procedural step that ensures all chat participants have the technical capability to use the chat. If an audio-video capture device is present the check returns a positive result and the chat session commences. If a negative result is returned then the process terminates 630.

Next, the user is entered into a pool of confirmed chat participants 540. All users within the pool have been through steps 510 and 520 with positive results. From this pool a sample of chat participants is selected 550. Size of the sample is preset by system administrators and may be changed via an administrator interface. In a preferred embodiment, the sample is selected using a pseudo-random technique such as “random number generators” seeded by machine time. Other techniques known to one of ordinary skill in the art may be used. After selection, the user may then be shown a web page specific to the chat. The selected sample is displayed on the aforementioned web page 560, where the user can review potential chat partners. Manner of displaying the sample may vary based on implementation. By way of example, all elements of the sample may be displayed at the same time, or may be displayed one at a time in rotation. Depictions of individual sample elements may be profile images, profile videos, icons, textual links, or the like.

If none of the elements of the sample appeal to the user as potential chat partners, the user may “shuffle” the sample. Shuffling is initiated via interaction with an on-screen indicia displayed via the chat specific web page. User interaction with the indicia returns the method to step 550 whereby a new pseudo-random sample is obtained from the pool of potential chat participants. Because other system users may enter and exit the potential participants pool at any time, the sample possibilities may be mathematically different from those present when the user initially accessed the multimedia multi-user chat. The new sample is displayed on the chat specific webpage for the user to review. Shuffling can continue until the user finds a chat participant. Filtering options are provided in the form of selectable indicia. The options restrict the selection of a sample of potential participants to only those persons meeting the selected criteria. Profession, locality, and age-range are examples of filters that can be selected by a user prior to interaction with the shuffle indicia. In this manner, the user reduces the pool of potential chat participants to include persons of a demographic in which the user is interested.

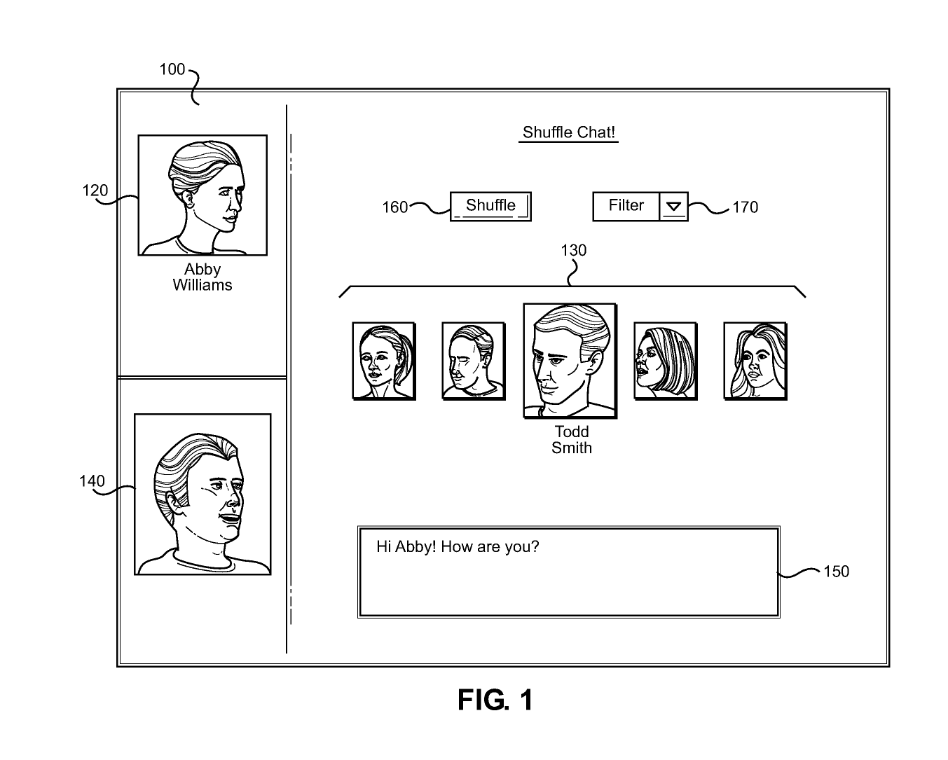

Selection of a chat participant occurs when the user interacts with the displayed depiction of the chat participant. A multimedia chat session is then initiated 570. An exemplary illustration of the chat specific web page is shown in FIG. 1. The chat specific web page 100 is an interface for the multi-user multimedia chat. The multimedia interactive chat may consist of an audio-video chat, facilitated by data streaming between the one or more servers and the respective clients over a network. The audio-video capture device operatively connected to each client captures real-time audio and video of each user's actions and speech. Live captured data is transmitted over the network. Textual dialog may also be commenced through keyboard input. This text appears in an on-screen dialog box 150.

Turning to FIG. 5, the chat specific web page is depicted in an exemplary arrangement. On one side of the page, the user's chat video is shown along with any pertinent links to the user's profile. Displayed depictions of the current sample of chat participants 130. Shuffle indicia 160 and filtering options 170 are displayed conspicuously near the sample depictions. A dialog box 150 is used to display text input by the user, and can optionally display text response from the chat participant. Additionally, an audio-video chat region 140 provides playback of the chat participant's streamed audio-video data. Variations on this implementation will be apparent to one of ordinary skill in the art and it should be understood that the implementation of the present method is not limited to the aforementioned illustration.

The method as described above protects participants in multimedia chats by requiring that they provide an audio-video clip of themselves prior to gaining access to a multi-user. Persons creating accounts under false identities are parsed out of the potential user pool during the review process. Community users can thus interact with other users with reduced concern about fraudulent users, predators, and solicitors. The method also provides for a filterable, multi-user chat that obtains and presents a user with a random sample of available chat participants. If the user is dissatisfied with the presented sample, a new one can be obtained by “shuffling” the chat. In this way, the present method gives users a safe way to meet and interact with new people.

To this point, the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method of generating providing a multimedia multi-user interactive session, comprising the steps of:
prompting a user to input personal information;
performing a first check for the presence of an audio-video capture device in operative communication with a user's computing device, wherein a lack of audio-video capture device results in termination of said method;
initiating capture of a multimedia file of said user;
recording said multimedia file for a pre-determined period of time;
storing said multimedia file;
submission of an account generation request comprising said personal information and said multimedia file by a user;
reviewing said account generation request for compliance with a predetermined rule set, and comparing playback of said multimedia file with said personal information for inconsistencies, wherein failure of said multimedia file to comply with said rule set or match said personal information results in termination of said method;
finalizing a user account based upon said personal information and said multimedia file;
initiating a multi-user multimedia interactive session upon interaction by said user with an on-screen indicia;
querying a database for the presence of a reviewed multimedia file associated with said user, wherein failure to return a positive result results in termination of said method ;
performing a second check for the presence of an active audio-video capture device in operative communication with said user's computing device, wherein a lack of audio-video capture device results in termination of said method;
adding said user within a pool of potential participants;
selecting a sample of pre-determined size from said potential participants;
displaying said sample;
initiating a multimedia interactive session between said user and a chat participant selected from said sample.

2. The method of claim 1, wherein said step of prompting a user further comprises displaying a series of prompts on a screen of a user's computing device.

3. The method of claim 1, wherein said step of initiating capture further comprises the steps of:
transmitting an audio-video capture initiation signal from a server over a network to said client computing device;
receiving said audio-capture transmission signal by said client computing device;
activating said audio-video capture device.

4. The method of claim 1, wherein said pre-determined period of time is set by a system administrator.

5. The method of claim 1, wherein said step said recording of said multimedia file is terminated upon receipt by said client computing device of an audio-video capture termination signal sent by a server over a network.

6. The method of claim 1, wherein said step of storing said multimedia file comprises transmission of said file to a server having a storage memory upon which said multimedia file is stored.

7. The method of claim 1, wherein said step of submission further comprises the steps of:
indexing said personal information and said multimedia file within a database; and
denoting said personal information and multimedia file to indicate that review is pending.

8. The method of claim 1, wherein said step of reviewing is performed by a system administrator manually reviewing multimedia file playback.

9. The method of claim 1, wherein said step of reviewing is performed by software adapted to perform facial recognition.

10. The method of claim 1, wherein said user is added to said potential pool of participants by adding an identifier associated with said user to said pool of potential participants.

11. The method of claim 1, wherein said selection of said sample is selected using a pseudoOrandom algorithm.

12. The method of claim 1, wherein said selection of said sample is restricted by demographic modifiers.

13. The method of claim 12, wherein said user may activate and deactivate said demographic modifiers.

14. The method of claim 1, wherein said sample is displayed on a chat specific web page.

15. The method of claim 1, wherein said sample is displayed as individual indicia that said user may interact with.

16. The method of claim 1, wherein said multimedia interactive session is an audio-video chat.
